(19) United States
(12) Patent Application Publication
(10) Pub. No.: US 2011/0024955 A1
(43) Pub. Date: Feb. 3, 2011

(54) Method of Fabricating Porous Soundproof Board

(75) Inventors: Sheng-Fu YANG, Longtan Township (TW); To-Mai Wang, Longtan Township (TW); Chun-Yen Yeh, Longtan Township (TW); Wen-Cheng Lee, Longtan Township (TW); Kin-Seng Sun, Longtan Township (TW); Chin-Ching Tzeng, Longtan Township (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/533,507

(22) Filed: Jul. 31, 2009

(51) Int. Cl. C04B 35/64

(52) U.S. Cl. 264/628

(57) ABSTRACT

A porous soundproof board is fabricated Recycled waste, like slag, is used for fabrication. Slag and ceramics are mixed to be poured into a network foam carrier. Then, the soundproof board is fabricated through sintering. Thus the board fabricated has great added values and is environmental protected with low cost.

### FIELD OF THE INVENTION

The present invention relates to fabricating a soundproof board; more particularly, relates to using a water-quenched slag as a base material for fabricating a porous soundproof board with recycled waste used and low cost

### DESCRIPTION OF THE RELATED ARTS

A prior art of a soundproof board is made of metal, which is sound absorbent and sound insulated. But metal is heavy, not light-weighted.

A second prior art is made of bamboo fiber, sawdust, resin and binchotan ash processed through blending and pressing. A metal is used to cover at outside with harden foaming material filled in. But its soundproof effect is not confirmed; and its structure is obtained through pressing, not sintering and so is not strong enough.

General porous material is obtained by accumulating granular particles to form granular pores in particular arrangement. On sintering, a binder, like a glass of SiO₂-A1₂O₃—R₂O—RO, is melted at a high temperature to bind ceramic particles with pores formed between the particles. Or, a material having a low burning temperature is further added like charcoal powder, sawdust, starch, polyvinyl alcohol (PVA), polymethyl-methacrylate (PMMA), polyvinyl butyral (PVB), polystyrene (PS), etc. There materials form pores in base material through sintering.

Although the above porous materials are sound insulated, waste materials are not used. Besides, these materials do not have high porosity and their soundproof effects are not satisfied. Hence, the prior arts do not fulfill all users' requests on actual use.

### SUMMARY OF THE INVENTION

The main purpose of the present invention is to use a slag as a base material for fabricating an environmental-protected porous sound proof board.

Another purpose of the present invention is to mix the slag with ceramic material to pour in to a sponge having porous network structure for fabricating a porous soundproof board with recycled waste used and low cost.

The third purpose of the present invention is to use the slag for saving fuel and cost and lowering a sintering temperature.

To achieve the above purposes, the present invention is a method of fabricating a porous soundproof board, comprising steps of: (a) providing a plasma melting slag as a base material and fine-crushing the plasma melting slag; (b) providing an admixture; (c) processing the plasma melting slag and the admixture through pulverization and screening to form a powder mixture; (d) storing the powder mixture; (e) adding water and a binder at a ratio of water and the binder to the powder mixture; (f) agitating the powder mixture, water and the binder to obtain a mixture; (g) forming a slurry from the mixture after being agitated (h) by using a pump, pouring the slurry into a carrier to be adhered to the carrier through rolling pressing; (i) processing hot-heating and then sintering to remove the carrier; and (j) processing cutting and trimming to obtain a porous soundproof board. Accordingly, a novel method of fabricating a porous soundproof board is obtained

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the view showing the characteristics of the porous soundproof boards;

FIG. 3 is the view showing the leached amounts of heavy metals from the water-quenched slag;

FIG. 4 is the view showing the reverberation time curves;

FIG. 5 is the view showing the αs sound absorption curve;

FIG. 6 is the view showing the αp sound absorption curves;

FIG. 7 is the view showing the sound pressure level curves at the source

FIG. 8 is the view showing the sound pressure level curves at the receiver side;

FIG. 9 is the view showing the reverberation time curves at the receiver side; and

FIG. 10 is the view showing the sound insulation curves.

### DESCRIPTION OF THE PREFERRED EMBODIMENT

The following description of the preferred embodiment is provided to understand the features and the structures of the present invention.

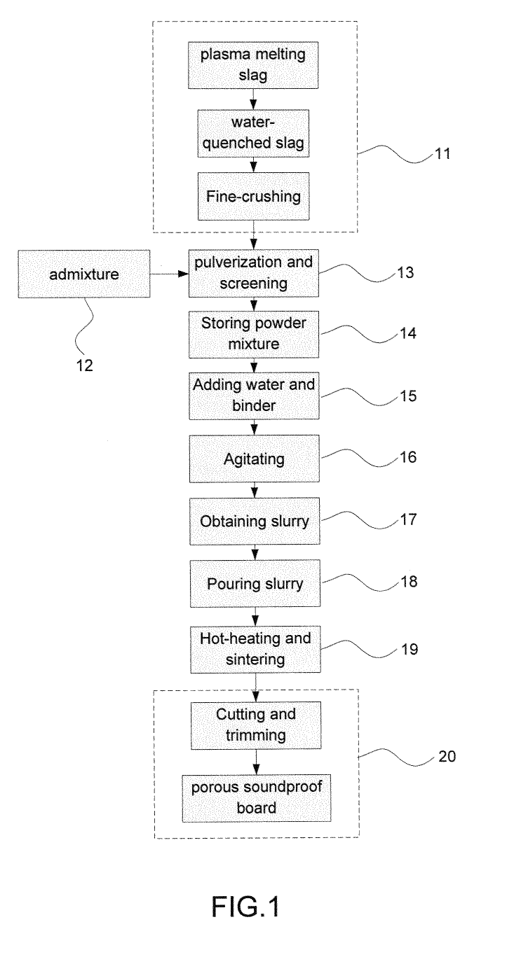

Please refer to FIG. 1, which is a flow view showing a preferred embodiment according to the present invention. As shown in the figure, the present invention is a method of fabricating a porous soundproof board, comprising the following steps:

(a) Fine-crushing base material 11. A plasma melting slag is provided as a base material to be fine-crushed, where the plasma melting slag is a water-quenched slag or an air-cooled slag.

(b) Providing admixture 12: Silicon carbide (SiC) is provided as an admixture, where the admixture can further be a mixture of SiC and aluminum oxide (Al2O3).

(c) Processing pulverization and screening 13: The plasma melting slag and the admixture are processed through pulverization and screening to obtain a powder mixture at a ration of the plasma melting slag to the admixture.

(d) Storing powder mixture 14: The powder mixture obtained after pulverization and screening is stored.

(e) Adding water and binder 15: Water and a binder are added at a ratio of water and the binder to the powder mixture, where the binder is an organic binder, like carboxymethyl cellulose (CMC).

(f) Agitating 16: The powder mixture, water and the binder are agitated to obtain a mixture.

(g) Obtaining slurry 17: Slurry is obtained from the mixture after being agitated.

(h) Pouring slurry 18: By using a pump the slurry is poured in to a carrier to be adhered to the carrier, where the carrier is made of sponge or porous silicone.

(i) Hot-heating and sintering 19: Sintering after hot-heating is processed to remove the carrier.

(j) Cutting and trimming 20: Cutting and trimming are processed to obtain a porous soundproof board.

Thus, a novel method of fabricating a porous soundproof board is obtained, where a ratio of water-quenched slag is added to lower sintering temperature for obtaining a dense green body while waste are used to be recycled.

On using the present invention, the following steps are taken:

(a1) A water-quenched slag is provided as a base material and is fine-crushed.

(b1) SiC and Al₂O₃ are provided at a ratio of 1:1 to be an admixture.

(c) The water-quenched slag fine-crushed and the admixture are separately processed through pulverization and screening at a ratio of 50:50 to obtain a powder mixture, where the powder mixture has a granular size of 200 meshes.

(d1) The powder mixture obtained after pulverization and screening is stored.

(e1) Water and an organic binder of CMC are added.

(f1) The powder mixture, water and the organic binder are agitated to obtain a mixture.

(g1) Slurry is obtained from the mixture after being agitated.

(h1) By using a pump, the slurry is poured into a sponge having 20 pores per inch and is pressed by rolling to be sunk in and adhered to the sponge.

(i1) After hot-heating, then sintering is processed at 1100° C. to remove the sponge.

(j1) After sintering, cutting and trimming are processed to obtain a porous soundproof board having a size of 30×30×2.5 cm.

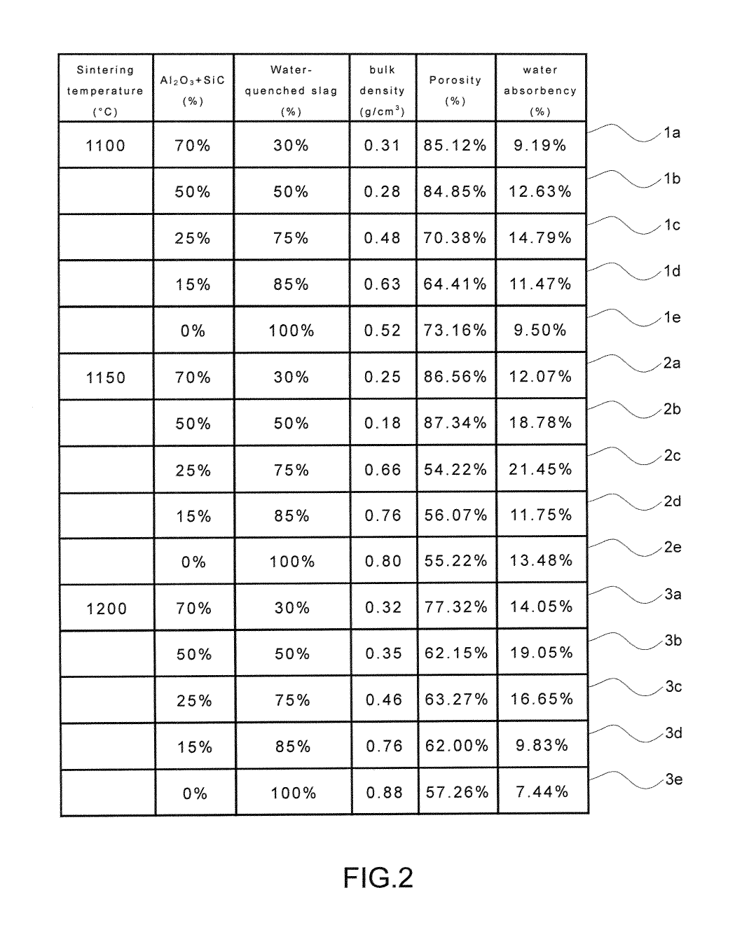

Please refer to FIG. 2 which is a view showing characteristics of porous soundproof boards. As shown in the figures porous soundproof boards separately added with 30% of water-quenched slag 1a, 50% of water-quenched slag 1b 75% of water-quenched slag 1c, 85% of water-quenched slag 1d and 100% of water-quenched slag 1e are obtained through sintering at 1100° C. where, as the water-quenched slag are added more than 50% pores on surface are melted and slumped and the porous structure on surface is destroyed.

Porous soundproof boards separately added with 30% of water-quenched slag 2a 50% of water-quenched slag 2b 75% of water-quenched slag 2c 85% of water-quenched slag 2d and 100% of water-quenched slag 2e are obtained through si nte ring at 1150° C. where, as the water-quenched slag are added more than 30%, pores on surface are melted and slumped and the porous structure on surface is destroyed; and, more particularly, the porous sound proof board added with 85% of water-quenched slag 2d and the porous soundproof board added with 100% of water-quenched slag 2e are seriously deformed.

Porous soundproof boards separately added with 30% of water-quenched slag 3a, 50% of water-quenched slag 3b, 75% of water-quenched slag 3c, 85% of water-quenched slag 3d and 100% of water-quenched slag 3e are obtained through sintering at 1200° C., where only the porous sound proofboard added with 30% of water-quenched slag 3a is deformed yet with the water-quenched slag less utilized. Hence, the water-quenched slag is a great flux for reducing sintering temperature to a temperature between 1100° C. and 1150° C., which is reduced to a range between 50° C. and 100° C.; and thus effectively reduces sintering cost. Furthermore, it shows that a preferred porous soundproof board according to the present invention can be fabricated at a sintering temperature of 1100° C. or 1150° C. with 30% to 50% of water-quenched slag added.

Through measuring bulk densities, porosities and water absorbency of the porous soundproof boards, the soundproof boards obtained at 1100° C. 1a˜1e shrink owing to the water-quenched slag added; and their bulk densities increase and their porosities decrease as more water-quenched slag is added. The soundproof boards obtained at 1150° C. 2a˜2e and the soundproof boards obtained at 1200° C. have the same situation as the soundproof boards obtained at 1100° C. Among them, the porous soundproof board obtained at 1100° C. with 50% water-quenched slag added is the best choice. Thus, after added with water-quenched slag each of the porous soundproof boards obtained according to the present invention has a bulk density between 0.18 g/cm³ and 0.88 g/cm³ and a porosity between 54.22 wt % and 87.34 wt %.

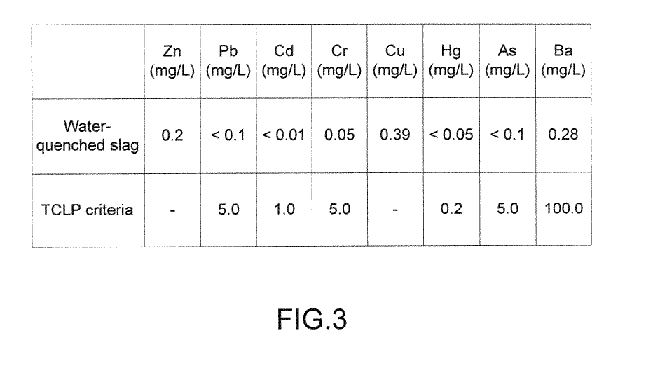

Please refer to FIG. 3 which is a view showing leached amounts of heavy metals from a water-quenched slag. As shown in the figure, through measuring leached amounts of heavy metals from a water-quenched slag it shows that a porous soundproof board added with a water-quenched slag obtained according to the present invention has serviceabiiity characteristics, safety, stability, and reusability with satisfied bulk density and porosity. Hence base material can be added with slag in fabrication procedure, where the slag acts like ceramics during sintering for fluxing to obtain a dense green body. For sintering is processed stably and few material are escaped, producing cost is thus reduced. Since the sintering temperature is reduced for 50° C. to 100° C., fuel for burning is saved and the cost is further reduced. Moreover, because a lot of slag can be added, waste is used to be recycled and environment is further protected. All these benefits are obtained by using the present invention.

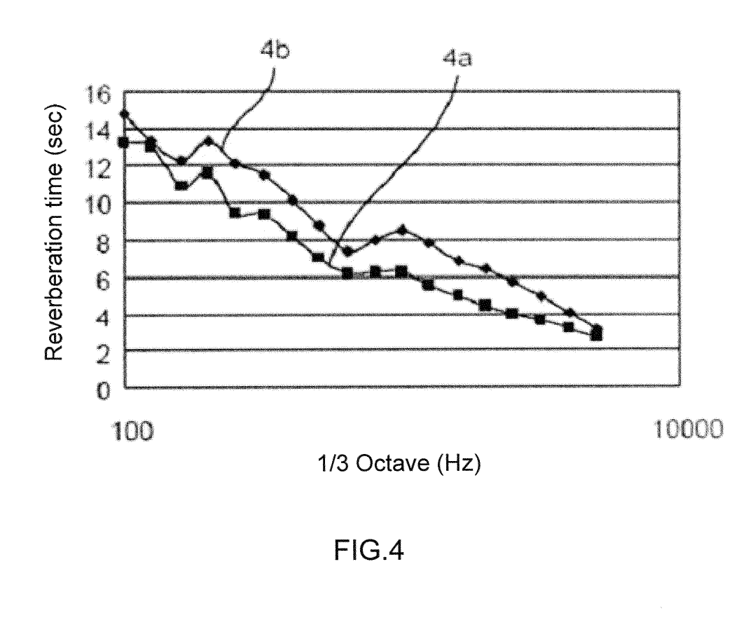

Please refer to FIG. 4 to FIG. 6, which are views showing reverberation time curves, a sound absorption curve and αₚ sound absorption curves. As shown in the figures, porous soundproof boards of 30×30×2.5 cm are arranged on a platform of 396×296 cm to measure sound absorbing coefficients in a bandwidth range between 100 Hz and 5 kHz to obtain α_{w} levels of sound absorbing coefficients based on ISO11654 following rules of ISO354.

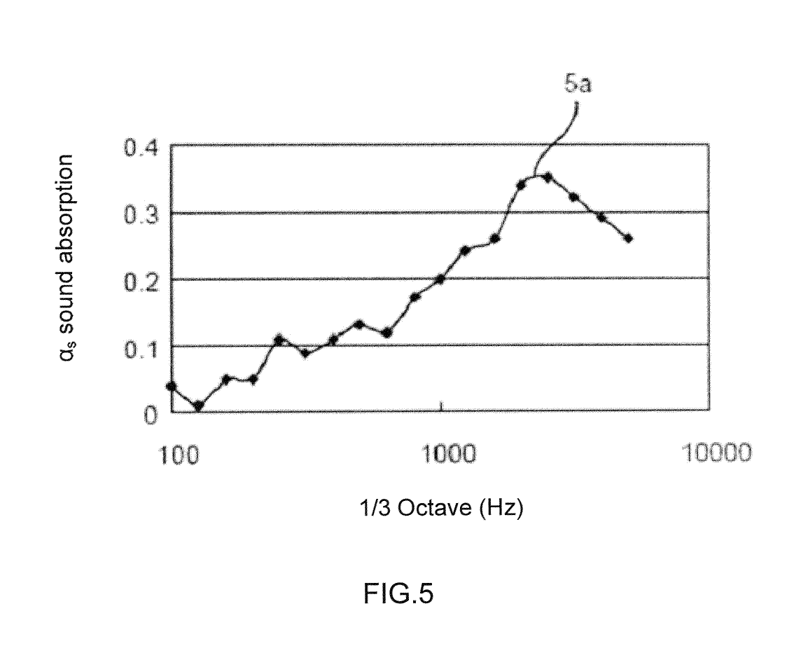

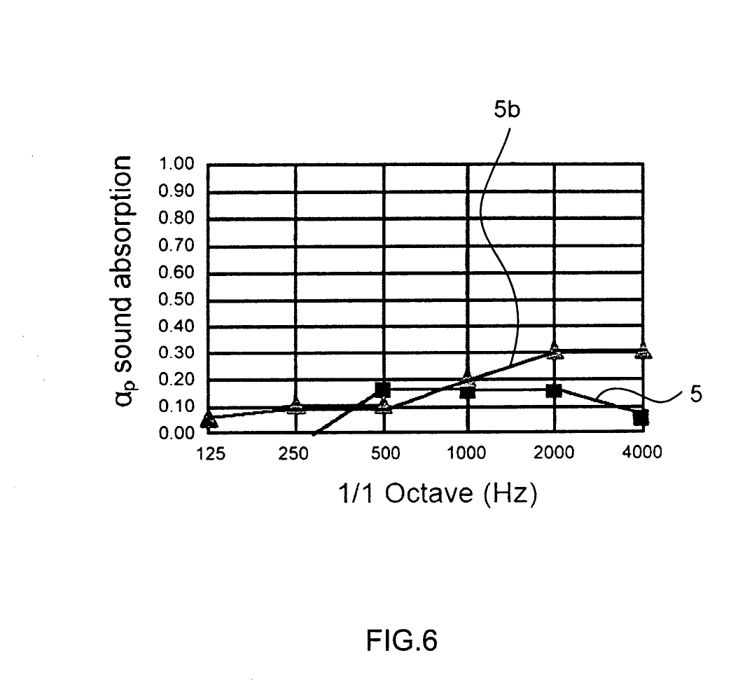

As shown by a reverberation time curve 4a of the porous soundproof board and a reverberation time curve 4b of a non-soundproof board, the reverberation time curve 4a of the porous soundproof board is lower than the reverberation time curve 4b of the non-soundproof board, which shows that the porous soundproof board fabricated according to the present invention has great sound absorbing effect. In FIG. 5 and FIG. 6, as shown by an αₛ sound absorption curve 5a and an αₚ sound absorption curve 5b of the porous soundproof board, the α_{w} sound absorbing rate is 0.15, which is E class according to the reference curve 5 of sound absorbing coefficient levels based on ISO 11654.

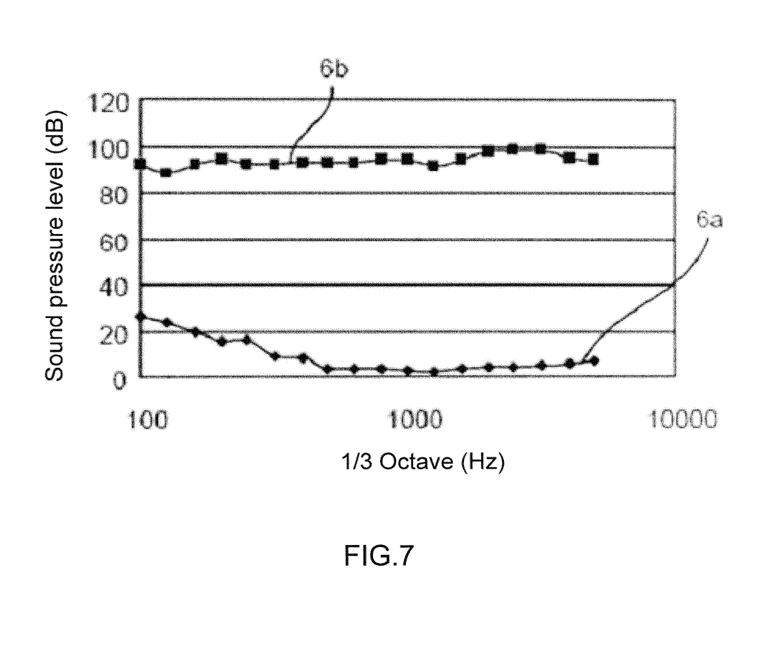

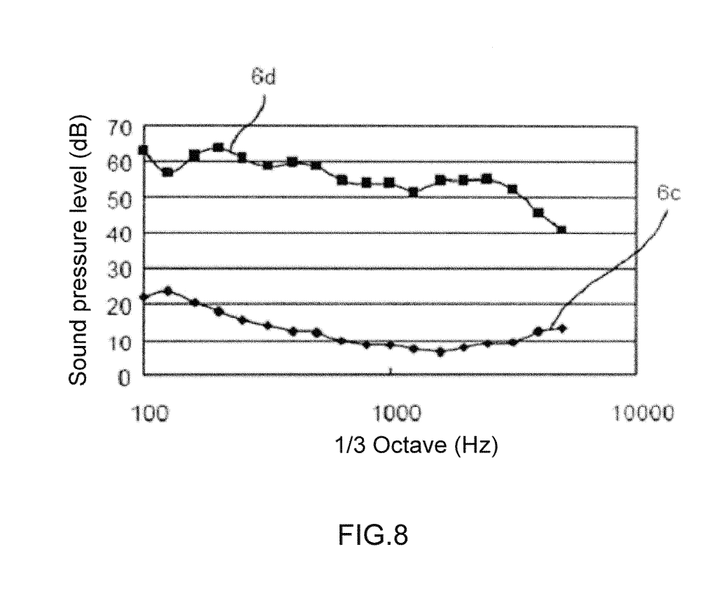

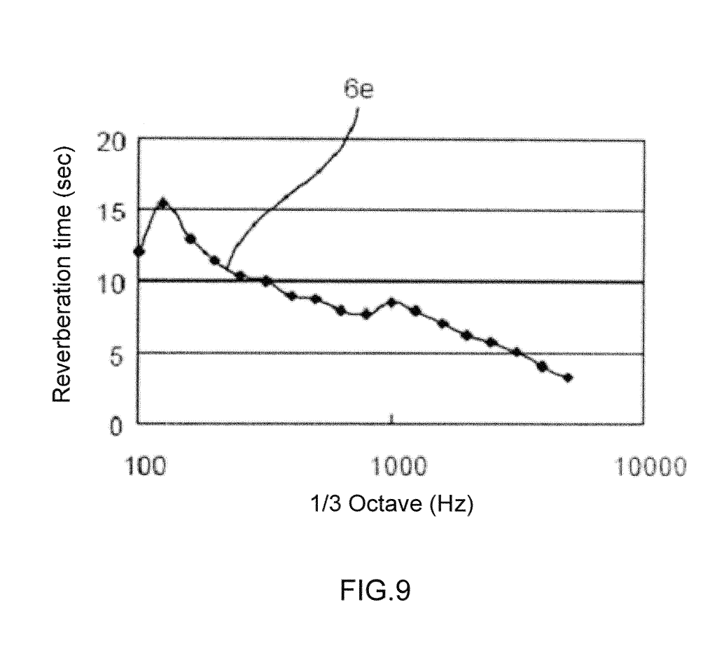

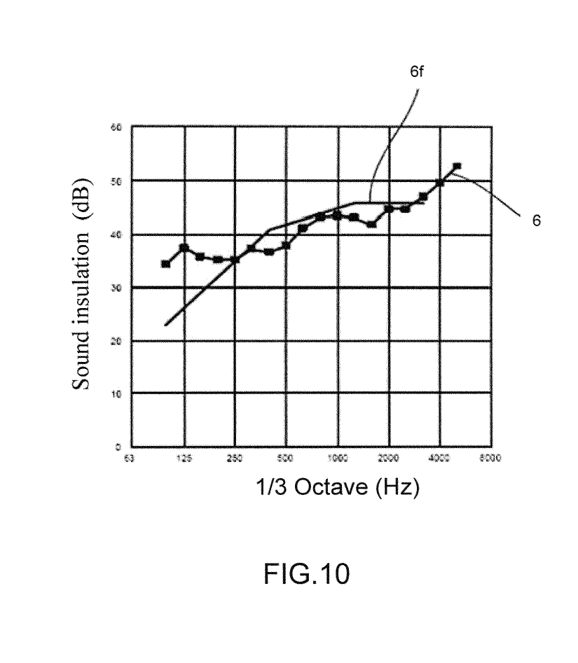

Please refer to FIG. 7 to FIG. 10, which are views showing sound pressure level curves at a source side and a receiver side; a view showing reverberation time curves at the receiver side; and a view showing sound insulation curves. As shown in the figures, for measuring sound insulation coefficient, an RC bare floor with a thickness of 120 mm is obtained. The bare floor is put on a frame with cotton insulation in between. A porous soundproof board of 30×30×2.5 cm is put on the bare floor. A source chamber and a receiver chamber are provided with a reverberation stop frequency at 100 Hz, an operation bandwidth of sound pressure between 100 Hz and 5 kHz, a standard deviation between 0.5 and 1.5 dB and a maximum sound insulation of R′max-78. As a result, background noise for the source chamber and the receiver chamber are [NR-10, 13.8 dB (A)] and [NR-5, 9.8 dB (A)], respectively

A sound insulation curve 6f for ⅓ octave is obtained from a background noise curve 6a and a sound pressure curve 6b at the source side of the source chamber a background noise curve 6c and a sound pressure curve 6d at the receiver side of the receiver chamber; and a reverberation time curve 6e at the receiver side of the receiver chamber. According to the reference curve 6 of sound insulation based on ISO717-1, the present invention lies in Rw(C;Ctr)=42(0;-2) dB.

The present invention fabricates a porous soundproof board through sintering a ceramic base material added with water-quenched slag where its sound absorbing level is E Class, sound insulation is 42 dB, and leached heavy metal amount for the water-quenched slag is conformed to environmental protection standards. Thus, the present invention is environmental protected with recycled waste used and low cost.

To sum up, the present invention is a method of fabricating a porous soundproof board where a water-quenched slag made of a plasma melting slag is used as a base material for fabricating a porous soundproof board with recycled waste used and low cost.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a porous soundproof board, comprising steps of:
(a) obtaining a plasma melting slag as a base material and fine-crushing said plasma melting slag;
(b) obtaining an admixture;
(c) processing said plasma melting slag and said admixture through pulverization and screening to obtain a powder mixture of said plasma melting slag and said admixture;
(d) storing said powder mixture;
(e) adding water and a binder at a ratio of water and said binder to said powder mixture;
(f) agitating said powder mixture, water and said binder to obtain a mixture;
(g) obtaining a slurry from said mixture after being agitated;
(h) by using a pump pouring said slurry into a carrier to be adhered to said carrier through rolling pressing;
(i) processing hot-heating and then sintering to remove said carrier; and
(j) processing cutting and trimming to obtain a porous sound proof board.

2. The method according to claim 1,
wherein, in step (a), said plasma melting slag is selected from a group consisting of a water-quenched slag and an air-cooled slag.

3. The method according to claim 1,
wherein, in step (c), said plasma melting slag and said admixture are mixed at a ratio of said plasma melting slag to said admixture selected from a group consisting of 30:70, 50:50, 75:25, 85:15 and 100:0; and
wherein 50:50 is preferred.

4. The method according to claim 1,
wherein said admixture is silicon carbide (SiC).

5. The method according to claim 1,
wherein said admixture is a mixture of SiC and aluminum oxide (Al₂O₃).

6. The method according to claim 5,
wherein SiC and Al₂O₃ are mixed at a ratio of 1:1.

7. The method according to claim 1,
wherein, in step (c), said powder mixture has a granular size between 200 and 300 meshes.

8. The method according to claim 1,
wherein said binder is an organic binder.

9. The method according to claim 8,
wherein said organic binder is carboxymethyl cellulose (CMC).

10. The method according to claim 1,
wherein said carrier is made of sponge.

11. The method according to claim 1,
wherein said carrier is made of porous silicone.

12. The method according to claim 1,
wherein, in step (h) said slurry is poured and pressed by rolling to be sunk in and adhered to said carrier.

13. The method according to claim 1,
wherein, in step (i) said sintering is a high-temperature sintering.

14. The method according to claim 14,
wherein said high-temperature sintering is a sintering at 1100 Celsius degrees (° C.).

15. The method according to claim 14, wherein said high-temperature sintering is a sintering at 1150° C.
